(19) United States
(12) Patent Application Publication
(10) Pub. No.: US 2012/0053739 A1
(43) Pub. Date: Mar. 1, 2012

(54) HOME ENERGY MANAGER SYSTEM

(75) Inventors: Joseph Mark Brian, Louisville, KY (US); Jay Andrew Broniak, Louisville, KY (US); Natarajan Venkatakrishnan, Louisville, KY (US); Byron K. Guernsey, Charlestown, IN (US); David C. Bingham, Lousville, KY (US)

(73) Assignee: General Electric Company

(21) Appl. No.: 12/892,130

(22) Filed: Sep. 28, 2010

(51) Int. Cl. G06F 1/26; G06F 3/048

(52) U.S. Cl. 700/287; 700/291; 715/771

(57) ABSTRACT

Apparatus and method for managing energy of a home or other structure are disclosed. An energy management system for a home network comprises a central device controller configured to communicate with energy consuming devices, energy generation devices and storage devices at a home. Power/energy measuring devices provide consumption measurements for the home and each device to the controller. A user interface client application configured to provide real time information to a user/consumer and to an energy provider/utility about the consumption of the home, each device, and receives inputs to modify the controllers and/or the devices.

### BACKGROUND

This disclosure relates to energy management, and more particularly to energy systems and methods with time of use (TOU) and/or demand response (DR) energy programs. The disclosure finds particular application to utility systems and appliances configured to manage energy loads to consumers through a communicating consumer control device, such as a home energy manager (HEM), programmable communicating thermostat (PCT), appliance controller, or the like.

This disclosure relates to energy management, and more particularly to electrical device control methods and electrical energy consumption systems. The disclosure finds particular application to energy management of appliances, for example, dishwashers, clothes washers, dryers, HVAC systems, etc.

Many utilities are currently experiencing a shortage of electric generating capacity due to increasing consumer demand for electricity. Currently utilities charge a flat rate, but with increasing cost of fuel prices and high energy usage at certain parts of the day, utilities have to buy more energy to supply customers during peak demand. If peak demand can be lowered, then a potential huge cost savings can be achieved and the peak load that the utility has to accommodate is lessened. In order to reduce high peak power demand, many utilities have instituted time of use (TOU) metering and rates which include higher rates for energy usage during on-peak times and lower rates for energy usage during off-peak times. As a result, consumers are provided with an incentive to use electricity at off-peak times rather than on-peak times and to reduce overall energy consumption of appliances at all times.

Presently, to take advantage of the lower cost of electricity during off-peak times, a user must manually operate power consuming devices during the off-peak times. However, a consumer may not always be present in the home to operate the devices during off-peak hours. In addition, the consumer may be required to manually track the current time to determine what hours are off-peak and on-peak.

There is a need to provide a system that can automatically operate power consuming devices during off-peak hours in order to reduce consumer's electric bills and also to reduce the load on generating plants during on-peak hours. Active and real time communication of energy costs of appliances to the consumer enable informed choices of operating the power consuming functions of the appliance.

Therefore, there is a need to provide an improved system that can enable control when power consuming devices are started after and/or before a DR event or TOU event, and thus, provide incentive for discretional power use to be moved into the off-peak timeframe so consumers can balance their level of comfort and convenience with a desired savings amount.

### SUMMARY

The present disclosure provides methods, systems and devices for appliances that enable appliance users to maintain comfort, reduce energy usage and energy costs.

In one embodiment, an energy management system for a home network comprising managed energy consuming devices respectively drawing different amounts of power in a home is provided. The energy management system is a home energy manager system comprising a central controller or central device controller with a memory. The controller is in communication with the managed energy consuming devices that respectively comprise device controllers. At least one power/energy measuring device is in communication with the controller and the managed devices, and is configured to collectively provide a total energy/power consumption measurement for the home as well as a power/energy consumption measurement for each managed device. For example, each device on the network reports its power consumption to the energy management system controller. Thus, each appliance will report its respective energy consumption. Through a separate communication mechanism, for example, a link to a smart meter on a primary Zigbee network, or it could be a separate energy measurement device on the secondary side of a Zigbee network the whole home energy consumption is obtained.

A user interface is communicatively coupled to the central controller for providing user information and receiving user commands thereat. The central controller has a processor, at least one transceiver and is configured to monitor and control energy consumption. In one embodiment of the HEM, the controller, for example, passes messages from the utility to the appliances, and the appliances are controlled locally therein at the appliance level. In other embodiments, the HEM could play a more integral part in making decisions about how energy is managed in the home. The central controller also provides feedback to the user interface display with respect to natural resource use and generation occurring at the home.

According to one aspect, an energy management system and method for one or more appliances comprises a controller for managing power consumption within a household or other structure. The controller is configured to receive and process a signal indicative of one or more energy parameters of an associated energy supplying utility, including at least a peak demand period or an off-peak demand period. The controller is configured to communicate with one or more appliances and facilitate operation of such appliances in one of a plurality of operating modes, including at least a normal operating mode and an energy savings mode in response to the received signal. The one or more appliances are capable of operating in the normal operating mode during the off-peak demand period and operating in the energy savings mode during the peak demand period. The controller is configured to facilitate the transition of the one or more appliances to the energy savings mode when the peak demand period begins and to the normal operating mode when the peak demand period is over based on signals received from the utility, and/or inputs provided by a user.

In another embodiment, a flow meter of an energy management system is configured to measure a flow of natural gas and/or water consumption. One or more renewable energy sources including solar photovoltaic production and wind energy production may also be included that have a means to measure and communicate power/energy. The controllers for the renewable energy sources are operatively coupled to the central controller. A thermostat controller is coupled to the central controller that is configured to have its schedule and operating parameters modified via a client application coupled to the central controller and provide energy consumption data to the user via a user interface of a client application.

### BRIEF DESCRIPTION OF THE DRAWINGS

FIG. 1 is a schematic illustration of an energy management system with one or more devices in accordance with one aspect of the present disclosure;

FIG. 2 is a schematic illustration of an energy management system with one or more devices in accordance with another aspect of the present disclosure; and

FIG. 3 is a flow diagram illustrating an example methodology for an energy management system.

### DETAILED DESCRIPTION

A home energy manager (HEM) comprises an electronic system having a central controller that provides a homeowner the means to monitor and manage their energy consumption through a combination of behavior modification and programmed control logic. For example, the control logic is contained in the managed device (refrigerator, water heater, etc.) The energy manager passes along signals to the managed devices, which instructs the managed devices what mode they should operate in. In effect, the energy manager makes decisions as to what operating mode (low, mid, high, critical) should be communicated to each managed device. The central controller provides real time feedback on electricity, water, and natural gas consumption as well as providing data on renewable energy generation occurring at the home, such as solar photovoltaic generation, wind generation, or any other type of renewable generation.

In one embodiment, the central controller is responsible for storing consumption data and providing data through an application programming interface (API). The central device operates as a data server for providing data to a client application running on a client device, which in turn presents that data to the consumer, such as in graph form with data of historical/present energy usage, generation and/or storage. The client application generates graphs of energy usage, generation and/or storage based on data received through the API of the central controller. Examples of client devices include a personal computer, smart phone or any other remote device in communication with the controller that has the processing and display capability to run such applications.

In another embodiment, data pertaining to the consumer's energy consumption, generated energy, and/or storage is displayed on a user display (e.g., LCD touch screen display) that is integral to the central controller. The user interface is also presented via a web server running on the central controller to any display device capable of running a web browser. The web browser interface is accessible to any device in communication with the central controller web server such as a networked PC or mobile phone. The central controller is configured to operate as a gateway device. Information between a utility or energy provider (e.g., an electrical, water, and/or gas utility) and a home area network (HAN) is managed by the central controller. For example, the HAN comprises communication between the central controller and devices within a home. The central controller also transmits and receives communication messages for demand response events from the utility.

In one embodiment, a ZigBee radio operating as a communication device is implemented to communicate between the central controller and devices within the home, while a second radio operates similarly between the central controller and the utility, such as for demand response event signals/price signals. Any communication protocol can be implemented and the present disclosure is not limited to ZigBee as one of ordinary skill in the art will appreciate. The central controller therefore operates as a gateway device by caching or storing information from devices within a home, such as status or energy consumption, or demand response events from the utility. The central device therefore provides the necessary information from the utility to the appliances/appliance microcontrollers for them to operate in accord with the utility signals and/or user preferences.

Consumption data is measured via sensors located at each of the incoming residential utility meters (e.g., water, gas, electrical meters). In one embodiment, this data is collected by radio modules and transmitted wirelessly back to the central device and/or to an energy provider. In another embodiment, the radios modules comprise a power line transceiver sending information to and from each sensor or power/energy measuring device, each appliance and an energy provider, for example.

A home's thermostat controller is also part of the Home Energy Manager and is designed to wirelessly communicate to the central device. The central device has an interface to the thermostat and allows for viewing and programming thermostat set points and schedules.

The central device is designed to accommodate multiple methods of wireless communication. This enables the central device to talk to the radio modules and also access information from the Internet. The central device has the following wireless capability: 802.11 WiFi, FM RDS receiver, and 802.15.4 compliant “Zigbee” radios. However, there are several ways to accomplish this communication, including but not limited to power line carrier (PLC) (also known as power line communication), FM, AM SSB, WiFi, ZigBee, Radio Broadcast Data System, 802.11, 802.15.4, etc.

The Home Energy Manager is designed to integrate with the electrical utilities' push towards Demand Side Management (DSM), also known as Demand Response (DR). The central device is capable of receiving electricity rates and schedules from the utility and using that information to implement pre-determined load shedding behavior across the whole home electrical load.

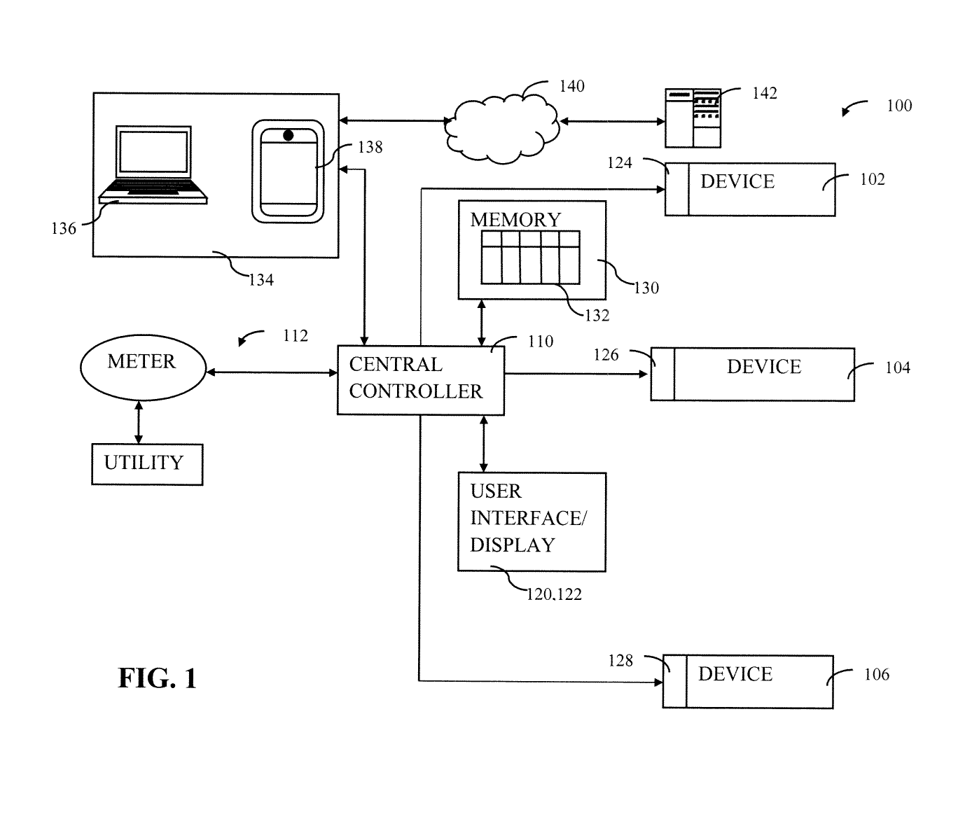

FIG. 1 schematically illustrates an exemplary home energy management system 100 for one or more energy consuming devices, such as devices 102, 104, 106 according to one aspect of the present disclosure. Each of the devices 102, 104, 106 can comprise one or more power consuming features/functions. For example, device 102 can be a refrigerator, device 104 an HVAC system, and device 106 a hot water heater, or they could be any other energy consuming device capable of having power consumption measured thereat. The devices may also be controllers, or other energy consuming devices other than appliances. The home energy management system 100 generally comprises a central device or central controller 110 for managing power consumption within a household. The controller 110 is operatively connected to each of the power consuming devices. The controller 110 can include a micro computer on a printed circuit board, which is programmed to selectively send signals to device controllers 124, 126, 128 of device 102, 104, and/or 106 respectively in response to the input signal it receives. Each device controller, in turn, is operable to manipulate energization of the power consuming features/functions of its respective energy consuming device.

The controller 110 is configured to receive a signal 112 by a receiver and process the signal indicative of one or more energy parameters and/or a utility state of an associated energy supplying utility, for example, including availability and/or current cost of supplied energy. There are several ways to accomplish this communication, including but not limited to PLC (power line carrier, also known as power line communication), FM, AM SSB, WiFi, ZigBee, Radio Broadcast Data System, 802.11, 802.15.4, etc. The energy signal may be generated by a utility provider, such as a power company or energy provider, and can be transmitted via a power line, as a radio frequency signal, or by any other means for transmitting a signal when the utility provider desires to reduce demand for its resources. The cost can be indicative of the state of the demand for the utility's energy, for example a relatively high price or cost of supplied energy is typically associated with a peak demand state/period and a relative low price or cost is typically associated with an off-peak demand state/period.

The controller 110 is configured to communicate to, control and operate the devices 102, 104, 106 in one of a plurality of operating modes, including at least a normal operating mode and an energy savings mode in response to the received signal. Specifically, each appliance 102, 104, 106 can be operated in the normal operating mode during the off-peak demand state or period and can be operated in the energy savings mode during the peak demand state or period. As will be discussed in greater detail below, the controller 110 is configured to communicate with each device and/or appliance to precipitate the return of the devices to the normal operating mode after the peak demand period is over. Alternatively, the control board of each appliance could be configured to receive communication directly from the utility, process this input, and in turn, invoke the energy savings modes, without the use of the centralized controller 110.

If the controller 110 receives and processes an energy signal indicative of a peak demand state or period at any time during operation of the appliances 102, 104, 106, the controller sends this information to each appliance. Once the appliance knows the energy mode, it makes the determination as to what specific features are enabled or disabled as part of the specified mode. The controller 110 is configured to communicate with the appliance control board 124 thru 128 to enable the appliance control board to govern specific features/functions of the appliance in accordance with the energy mode information received from controller 110, for example, to operate at a lower consumption level and determine what that lower consumption level should be. This enables each appliance to be controlled by the appliance's controller where user inputs are being considered directly, rather than invoking an uncontrolled immediate termination of the operation of specific features/functions of an appliance from an external source, such as a utility. It should be appreciated that the controller 110 can be configured with default settings that govern normal mode and energy savings mode operation. Such settings in each mode can be fixed, while others are adjustable to user preferences to provide response to load shedding signals.

In one embodiment, the central controller 110 operating as a gateway transmits signals received from the utility (via smart meter or other means) along to devices, such as appliances 102, 104, and 106 connected to a home area network (HAN). The central controller 110 controls which devices shed load by going into an energy savings mode or other power deferred state. In one aspect of the HEM, it is merely relaying messages from the utility to the appliances. It is possible that the user will be able to configure their system such that certain appliances (e.g., hot water heater) will always respond to a utility signal, and other appliances (such as a refrigerator) may only respond during a critical peak. This behavior is at the user's discretion. In another aspect of the HEM, it may actually be shifting energy consumption activities (for example, when to heat water) based on information that has nothing to do with demand response signals. In a house equipped with a solar array, but no battery storage, the best time to consume energy may be in the middle of a hot sunny day, regardless of price. Depending on the control algorithm (demand response vs. energy manager) being used, the behavior of the device may be different.

The controller 110 includes a user interface 120 having a display 122 and control buttons for making various operational selections. The display can be configured to provide active, real-time feedback to the user on the cost of operating each appliance 102, 104, 106. The costs are generally based on the current operating and usage patterns and energy consumption costs, such as the cost per kilowatt-hour charged by the corresponding utility. The controller 110 is configured to gather information and data related to current usage patterns and as well as current power costs, and generate historical usage charts therefrom. This information can be used to determine current energy usage and cost associated with using each device/appliance in one of the energy savings mode and normal mode. This real-time information (i.e., current usage patterns, current power cost and current energy usage/cost) can be presented to the user via the display.

In one embodiment, controller 110 is operable to provide the user interface/display 120, 122 feedback on natural resource use (e.g., electric, gas, water, and/or other) and the generation of natural resources at the home, for example. This information can be collected from power measuring devices, such as a power meter.

The central controller 110 is the central brain for the entire system. In one embodiment, an optional LCD touch screen is used for displaying current energy consumption, historical energy consumption, thermostat set points and schedule, and/or weather forecast information that may be used for determining optimal times to run certain devices, generate energy on-site, and/or store energy.

In one embodiment, the central controller 110 operates as a data server. The central controller 110 provides data received from devices within the home through an an API (Application Programming Interface) to client applications, which in turn format the data to be presented to the user, such as in graphs or other type of displays. In another embodiment, the controller 110 operates as a web server for serving web pages to a browser device and/or a sending interface over an IP connection acting as a website.

The controller 110 communicates to the sensor radios via one or more wireless radios. The interface radios are ZigBee (802.15.4), WiFi (802.11), and an FM RDS receiver. The device controller 110 can also include USB ports for adding additional functionality.

In one embodiment, the controller 110 connects via either Ethernet or WiFi to the homeowner's router and to a client application 134 in a personal computer 136 and/or a mobile device 138. The controller 110 also has the ability to periodically push data to a central server on the Internet 140 of FIG. 1. This allows for remote service and monitoring capability. A server 142 can keep records of all homes therein that may be accessed remotely via the Internet.

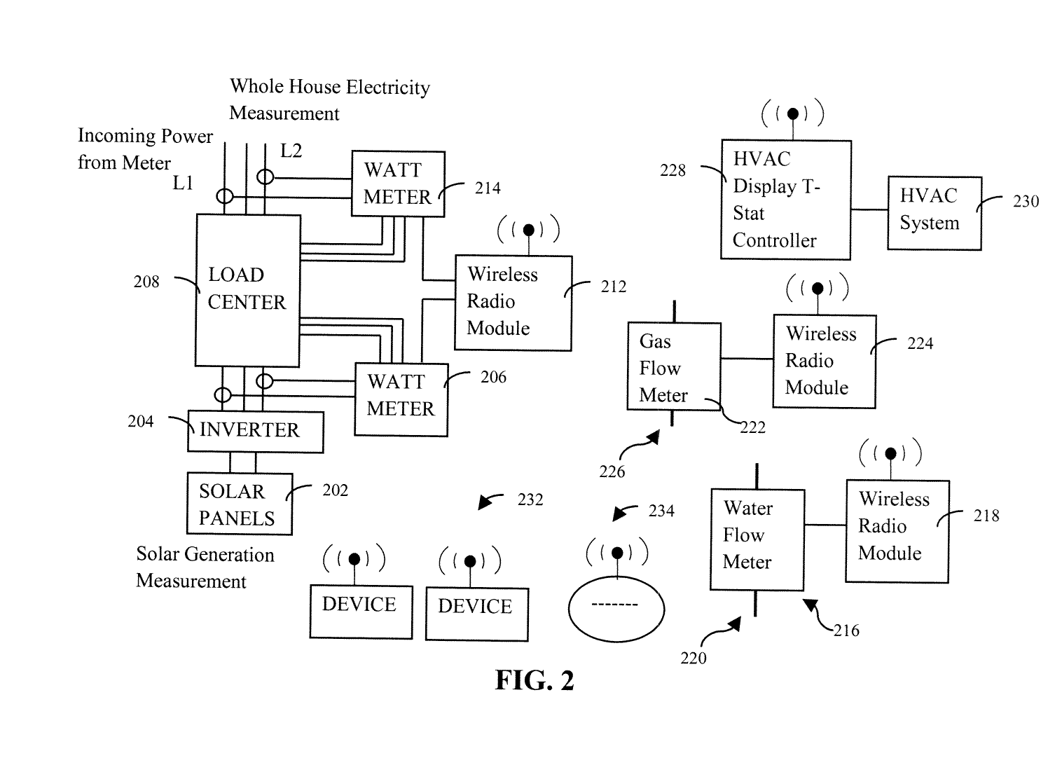

For example, FIG. 2 illustrates an example of measuring devices for various types of sources of energy. The HEM system 100 communicates wirelessly, for example, to radios that are connected to various sensors. Measurement of electricity includes at least a power meter, for example, and a wireless radio module. The diagram shown in FIG. 2 is one example for measuring power in a system according to the present disclosure. For example, the power source (whole home electricity, solar, or wind power) has an internal means of knowing its' energy consumption and is outfitted with a communication module to relay that information to the central controller. A further example provides for a watt meter and current transducers to make measurements in system and communicate those to the central controller. Also, a wireless radio module may be provided that has an integrated watt meter and is capable of directly receiving input from the current transducers and then transmitting energy consumption to the central controller.

In one embodiment, one or more current transducers are attached to a radio module. The radio module reads an analog signal from the current transducers that is proportional to current and uses that information to calculate instantaneous power. Power is integrated over time to calculate energy (e.g., watt-hours) that is sent to the central controller 110. In one embodiment, current transformers are used to measure the current flow. For example, two current transformers are placed around the incoming power legs (L1 and L2) to the home. These pick up a current that is proportional to the load the house is consuming. This current is sent to the Watt Meter 214. The Watt Meter also monitors voltage at L1, L2, relative to N and it outputs a communication signal based on the amount of consumed electricity. This signal is sent to a radio module 212 that sends the information back to the central device controller 110.

In another embodiment, the home can be outfitted with a “smart” electric meter as the meter 214 or other meters in the system, for example. This meter wirelessly communicates directly with the central device controller 110. The home's “smart” meter can be configured to establish a communication link for communicating a signal based on electrical consumption. This communication is sent from the smart meter to the central controller. A similar process is implemented for solar measurement as with the electricity measurement. Energy comes in through an inverter 204 and is measured by one of the aforementioned electricity measurement methods. A radio module 212 comprises a wireless radio module as discussed above for communicating measurement information to the central device controller 110.

Alternately, a renewable energy device such as solar or wind generation that is equipped with a compatible method of communication can directly transmit its energy consumption directly to the central controller without the need for an external measurement system.

The two current transformers are placed around the lines (L1 and L2) that are run from the solar inverter 204 to the home's load center 208. These pick up a current that is proportional to the power generated by the solar panels. This current is sent to the watt meter 206, which also monitors voltage at L1, L2, and outputs a pulse of varying frequency based on the amount of generated electricity. This pulse is sent to a radio module 212 that sends the information back to the central device controller 110.

There are additional methods of measuring solar generation that may also be implemented. For example, the inverter can provide generation data via a serial data stream to a radio module or directly to the central device wirelessly.

The system 100 has various alternatives for measuring power. Examples described herein are as follows:

### Example 1

Device self-measures its energy and communicates it to the central controller via standard protocol. For example, a solar inverter is equipped with a Zigbee radio and can directly communicate its power consumption to the central controller via Zigbee, which is also used for appliance devices, for example.

### Example 2

A set of current transducers are installed to an external radio module, measure the power, and transmit it to the central controller. This example can apply to a solar inverter, which does not report power to an energy provider, for example.

### Example 3

A set of current transducers are installed and connected to an external power meter that delivers a pulse output to the input of our radio module.

Other natural resources may also he monitored by the central controller 110. For example, water measurement may be monitored where the system includes a water meter 216 and a wireless radio module 218. The water meter 216 is inserted into the home's incoming water line 220. The water meter 216 gives a output for each gal/liter/etc. of water consumed, for example. This output is sent to the radio module 218 that in turn sends the information back to the central controller 110. In one embodiment, the water utility can directly send the consumption data to the central device controller 110 via any available means, including 802.15.4 Zigbee, the Internet or IP connection 140.

A natural gas measurement includes a natural gas flow meter 222 with a pulse output and a wireless radio module 224. The gas meter 222 is inserted into the home's incoming gas line 226. The gas meter 222 also gives a pulse output for each cu. ft. of gas consumed. This pulse is sent to the radio module 224 that sends the information back to the central device. In addition, the gas utility can directly send the consumption data to the central device controller 110 via any available means, including 802.15.4 Zigbee, or the Internet (IP connection) 140.

An HVAC controller 228 is a standard home thermostat used to program temperature set points and schedules for the furnace and air conditioning systems. This controller 228 contains a radio module 230 in order to bi-directionally communicate schedule and temperature information with the central device.

Local utility and rate information is also broadcast at blocks 234 from the utility or energy provider to the controller 110 directly. The controller 110 can receive rate and schedule information as well as demand side management DSM signals to pass them on to the household appliances, such as devices 232.

The devices 232 may also transmit energy/power consumption information to the central controller 110. The controller 110 further comprises a memory 130 having at least table 132 of FIG. 1 that collects energy consumption, generation and/or storage data for a home or other structure (e.g., warehouse, business, etc.). The table may additionally comprise variables associate with the heating and cooling conditions of the home, for example. A table is generated for each monitored device that includes historical home data and data that is currently updated, which may be used in a client application running on a device, such as a computer or mobile phone, for presenting graphs or other data to the user.

The operation of each device 102, 104, 106 may vary as a function of a characteristic of the utility state and/or supplied energy. Because some energy suppliers offer time-of-day pricing in their tariffs, price points could be tied directly to the tariff structure for the energy supplier. If real time pricing is offered by the energy supplier serving the site, this variance could be utilized to generate savings and reduce chain demand.

In one embodiment, the system 100 has the capability for remote software upgrades and bug fixes. For example, if a software bug is found, this feature will allow the fix to be propagated quickly and in a very cost effective manner. The energy management system will be capable of periodically connecting with a secure server that can distribute software patches and receive data uploads in an automated fashion.

Building on the ability of the central controller to periodically upload data to a central server, the system 100 has the capability for the homeowner to log onto a secure web portal and view data from their home. This will allow consumers additional flexibility to monitor their home while away.

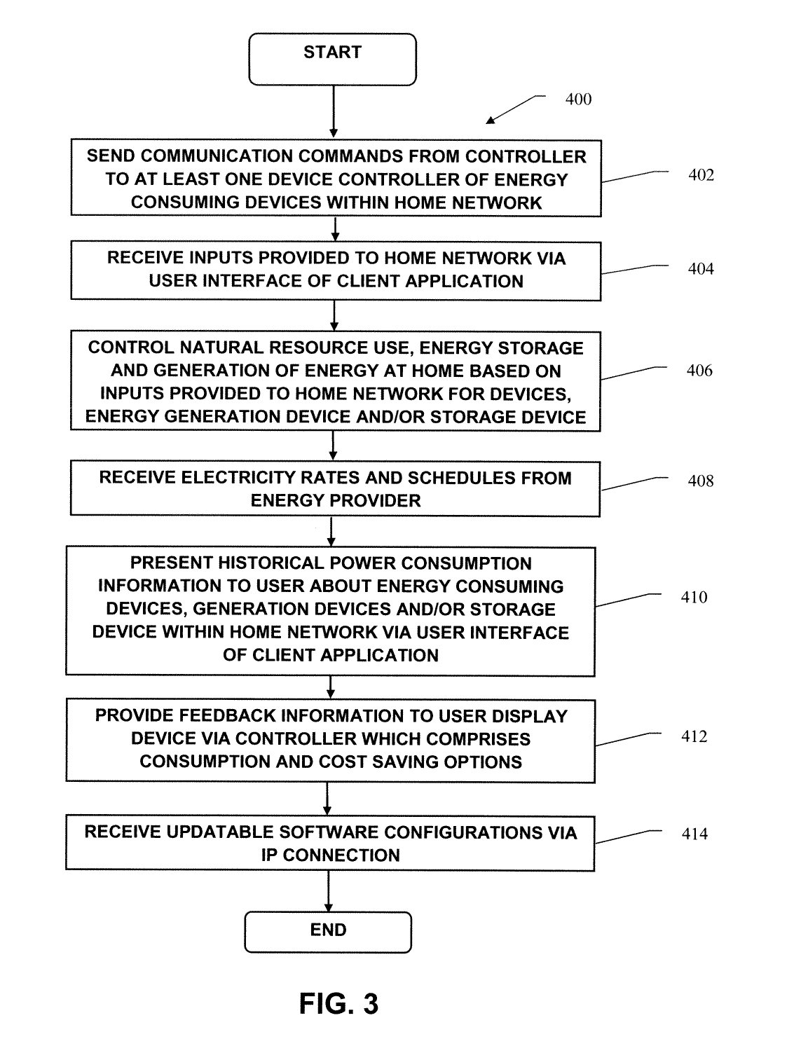

FIG. 3 illustrates an exemplary method 400 for managing energy of a structure (e.g., a residential home, or a business). While the method 400 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

The method 400 begins at start. At 402 communication commands are sent from a central controller with a memory to at least one device controller of energy consuming devices within a home network for a home energy management system. The energy consuming devices comprise at least one demand response appliance configured to manage power consumption by responding to communication commands from the device controller. The energy consuming devices comprise, for example, an HVAC, a refrigerator, a dishwasher, a dryer and any other power consuming device configured to operate at power levels detected by a power/energy measuring device, such as pool pumps, thermostats, and/or smart switches.

At 404 the HEM system receives inputs provided to the home network via a user interface of a client application. The client application can be in a personal computer, a mobile phone, and/or like device, for example.

At 406 the HEM system controls natural resource use among the energy consuming devices, any energy storage devices, and generation of energy at the home based on inputs provided to the home network for the energy consuming, devices, energy generation devices and/or any storage means (e.g., batteries, capacitors, etc.) on site and linked to the central controller of the HEM.

At 408 the HEM system receives electricity rates and schedules from an energy provider, as discussed in more detail above. At 410 historical power consumption information is presented to the user in a user interface of the client application about energy consuming devices, generation devices and/or storage devices within the home network.

At 412 feedback information is provided in the user display device via the controller comprising consumption and other relevant historical data. At 414 the system receives updatable software configurations and uploads historical data from a memory via an IP connection.

In one embodiment, the power generation devices can comprise a solar panel, a wind power generation device, and/or other generation device and the natural resources comprises electricity, water, and/or natural gas, for example.

The invention has been described with reference to the preferred embodiments. Obviously, modifications and alterations will occur to others upon reading and understanding the preceding detailed description. It is intended that the invention be construed as including all such modifications and alterations.

What is claimed is:

1. An energy management system for a home network comprising managed devices and energy consuming devices in a home, respectively drawing different amounts of power from a source of power, the system comprising:
a central controller with a memory in communication with the managed energy consuming devices that respectively comprise a device controller;
a plurality of power/energy measuring devices in communication with the controller and the managed devices configured to collectively provide a total energy/power consumption measurement for the home and an power/energy consumption measurement for each managed device; and
a user interface communicatively coupled to the controller for providing user information and receiving user commands thereat;
wherein the controller having a memory, a processor and at least one transceiver, is configured to monitor and manage energy consumption of each of the managed devices by sending communications to each of the managed devices via the device controller respectively and to provide real time feedback to the user interface with respect to natural resource use and generation of energy usage occurring at the home.

2. The system of claim 1, wherein the user interface comprises a client application that is configured to provide real time information to a user about the total energy consumption of the home and each device, and to receive inputs from a user to modify the controller and/or the devices.

3. The system of claim 2, wherein the user interface comprises a display for displaying the feedback in real time.

4. The system of claim 1, wherein the power source is a utility and the controller is configured to receive communication from at least one power/energy measuring device comprising a smart meter in communication with the central controller, and the devices respectively comprise a demand response appliance configured to manage power consumption by responding to a communication from the controller, and wherein the controller is configured to receive electricity rate and schedules from the utility to implement pre-determined load shedding for the managed devices in the home.

5. The system of claim 1, wherein the plurality of devices comprises an HVAC, a refrigerator, a dishwasher, a dryer and any other appliance or power switch or energy consuming device configured to operate at power levels detected by the power/energy measuring device.

6. The system of claim 2, wherein the source of power for energizing the respective managed devices comprises at least one of an electrical utility, a natural gas supplier, a solar power, wind power, or other on-site power generator.

7. The system of claim 1, wherein the transceiver comprises a wireless transceiver for wirelessly sending information to and from each power/energy measuring device, each appliance and the power source.

8. The system of claim 1, wherein the transceiver comprises a power line transceiver sending information to and from each power/energy measuring device, each appliance and the power source, and wherein communication with power source is by internet (IP), wireless, or power line carrier.

9. The system of claim 6, wherein the memory comprises a dynamic table for storing variable, updateable and dynamic energy consumption and energy cost readings and historical energy consumption data with respect to electricity, water, natural gas, solar energy consumption and energy generation occurring at the home.

10. The system of claim 6, further comprising:
a flow meter configured to measure a flow of natural gas and/or water consumption in the home operatively coupled to the central controller;
a solar power generation device having a solar power/energy measuring device operatively coupled to the central controller;
a wind power generation device having a wind power/energy measuring device operatively coupled to the central controller;
a gas power generation device having a gas power/energy measuring device operatively coupled to the central controller; and
a thermostat controller operatively coupled to the central controller that is configured to be modified via the client application coupled to the central controller and provide consumption data to the user interface.

11. The system of claim 10, wherein the user interface display is configured to receive programming instructions that modify setpoints of the thermostat controller and programming schedules.

12. (canceled)

13. The system of claim 1, wherein the central controller is configured to receive updatable software configurations and upload elements of the database table via an IP connection.

14. The system of claim 1, wherein the central controller is configured to retrieve weather forecast information and make it available to the client application, to communicate remote service diagnostics and optimize appliance energy consumption devices based on forecast weather conditions.

15. An energy management system for a home network comprising managed devices in a home respectively drawing different amounts of power from a power source, comprising:
a central controller with a memory in communication with the managed devices that respectively comprise a device controller;
one or more power/energy measuring devices in communication with the controller, wherein the managed devices are operatively coupled to the one or more energy measuring device for measuring energy consumption thereat and communicating on the network a measurement to the controller; and
a user interface hosted on a device that is in communication with the controller for providing user information and receiving user commands thereat;
wherein the controller having a memory and a processor, is configured to monitor and manage energy consumption, energy generation and storage of energy at the home with respect to each of the managed devices via the device controller respectively and to provide real time feedback to the user interface display with respect to natural resource use, generation and storage occurring at the home.

16. The system of claim 15, wherein the memory comprises a dynamic table having variable, updateable and dynamic power consumption readings and historical power consumption readings based on communication with the monitored devices with respect to electricity, water, natural gas and solar power consumption, generation and storage at the home.

17. The system of claim 15, wherein the power source includes a natural gas supplier and a solar power generator and wherein at least one of the managed devices is powered by natural gas, the system further comprising:
a flow meter configured to measure natural gas and/or water consumption of the at least one gas powered managed device and a solar generation device having a solar power/energy measuring device operatively coupled to the central controller for monitoring the solar power consumption by one or more solar power energized managed devices; and
a thermostat controller coupled to the central controller that is configured to be modified via a client application coupled to the central controller and provide consumption data to the user via the user interface of the client application, wherein the user interface display is configured to receive programming instructions that modify the thermostat controller setpoints and power consumption schedules, and wherein the central controller is configured to receive updatable software configurations via an IP connection.

18. A method for an energy management system for energy consuming devices within a home network which network includes a power meter for measuring power consumed by each energy consuming device of the network, and a controller communicatively linked to the power meter and the at least one device, the controller including at least one memory for storing data and for storing executable instructions, the method comprising:
sending communication commands from the controller to at least one device controller of the energy consuming devices within the home network;
receiving inputs provided to the home network via the user interface of a client application;
controlling natural resource use, energy storage and generation of energy at the home based on the inputs provided to the home network for the devices, an energy generation device and/or a storage device;
receiving electricity rates and schedules from an energy provider to implement pre-determined load shedding for an electrical load of the home; and
presenting historical power consumption information to the user about the energy consuming devices, generation devices and/or a storage device within the home network via the user interface of a client application.

19. The method of claim 18, further comprising: providing feedback information to a user display device via the controller which comprises power consumption and cost saving options calculated by the controller based on historical power consumption data stored in a table of the memory.

20. The method of claim 18, wherein the energy consuming devices comprise at least one demand response appliance configured to manage power consumption by responding to communication commands from the device controller, wherein the energy consuming devices comprise an HVAC, a refrigerator, a dishwasher, a dryer and any other power consuming device configured to operate at power levels detected by a power/energy measuring device, wherein the power generation device comprises a solar panel and/or a wind power generation device, wherein the natural resource comprises electricity, water, and/or natural gas.

21. The method claim 18, further comprising:
receiving updatable software configurations via an IP connection;
wherein the user interface of the client application presents power consumption information, generation information and/or storage information based on the energy consuming devices, generation device and storage device respectively in the home network on a mobile phone, and/or a home computer, and is configure to receive the inputs from the user to control the same.
